(19) United States
(12) Patent Application Publication
(10) Pub. No.: US 2024/0426009 A1
(43) Pub. Date: Dec. 26, 2024

(54) PROTON EXCHANGE MEMBRANE AND CATALYST-COATED PROTON EXCHANGE MEMBRANE

(71) Applicant: UOP LLC, Des Plaines, IL (US)

(72) Inventors: Zhihao Shang, Mount Prospect, IL (US); Shurong Yang, Naperville, IL (US); Dennis F. van der Vliet, Skokie, IL (US); Chunqing Liu, Arlington Heights, IL (US)

(21) Appl. No.: 18/585,222

(22) Filed: Feb. 23, 2024

Related U.S. Application Data
(60) Provisional application No. 63/509,806, filed on Jun. 23, 2023.

(51) Int. Cl. C25B 13/08; C25B 9/23

(52) U.S. Cl. CPC C25B 13/08; C25B 9/23

(57) ABSTRACT

Proton exchange membranes are described. The proton exchange membranes comprise a reinforced membrane, a continuous nonporous hydrogen recombination catalyst coating layer comprising a mixture of hydrogen recombination catalyst and a proton conducting ionomer, and a continuous nonporous cross-linked polyelectrolyte multilayer coating comprising alternating layers of a polycation polymer and a polyanion polymer. Catalyst coated membranes incorporating the proton exchange membranes and methods of making the proton exchange membranes are also described.

### RELATED APPLICATIONS

This application claims priority to U.S. Provisional Patent Application Ser. No. 63/509,806, filed on Jun. 23, 2023, the entirety of which is incorporated herein by reference.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting water into hydrogen and oxygen; the reaction is given by Eq. 1 below. The water electrolysis process is an endothermic process and electricity is the energy source. Water electrolysis has zero carbon footprint when the process is powered by renewable energy sources, such as wind, solar, or geothermal energy. The main water electrolysis technologies include alkaline electrolysis, proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115, such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

Water electrolysis reaction: 2H₂O→2H₂+O₂ (1)

Oxidation reaction at anode for PEMWE:2H₂O→O₂+4H⁺+4e⁻ (2)

Reduction reaction at cathode for PEMWE: 2H⁺+2e⁻→H₂ (3)

AEMWE is a developing technology. As shown in FIG. 2, in the AEMWE system 200, an anode 205 and a cathode 210 are separated by a solid AEM electrolyte 215. Typically, a water feed 220 with an added electrolyte such as dilute KOH or K₂CO₃ or a deionized water is fed to the cathode side. For some cases, the water feed 220 with an added electrolyte such as dilute KOH or K₂CO₃ or a deionized water is fed to the anode side or both the cathode and the anode sides. The anode and cathode catalysts typically comprise platinum metal-free Ni-based or Ni alloy catalysts. At the negatively charged cathode 210, water is reduced to form hydrogen 225 and hydroxyl ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂ 225 and O₂ 230 produced in the water electrolysis reaction. The AEM 215 allows the hydrogen 225 to be produced under high pressure up to about 35 bar with very high purity of at least 99.9%. Reduction reaction at cathode for AEMWE:

4H₂O+4e⁻→2H₂+4OH⁻ (4)

Oxidation reaction at anode for AEMWE:

4OH⁻→2H₂O+O₂+4e⁻ (5)

AEMWE has an advantage over PEMWE because it permits the use of less expensive platinum metal-free catalysts, such as Ni and Ni alloy catalysts. In addition, much cheaper stainless steel bipolar plates can be used in the gas diffusion layers (GDL) for AEMWE, instead of the expensive Pt-coated Ti bipolar plates currently used in PEMWE. However, the largest impediments to the development of AEM systems are membrane hydroxyl ion conductivity and stability, as well as lack of understanding of how to integrate catalysts into AEM systems. Research on AEMWE in the literature has been focused on developing electrocatalysts, AEMs, and understanding the operational mechanisms with the general objective of obtaining a high efficiency, low cost and stable AEMWE technology.

The anode in an electrochemical cell is the electrode at which the predominant reaction is oxidation (e.g., the water oxidation/oxygen evolution reaction electrode for a water electrolyzer). The cathode in an electrochemical cell is the electrode at which the predominant reaction is reduction (e.g., the proton reduction/hydrogen evolution reaction electrode for a water electrolyzer).

The membrane is one of the key materials that make up an electrolysis cell and is an important driver for safety and performance. Some important properties for membranes for electrolysis include high conductivity, high ionic permeability, high ionic exchange capacity (for ion-exchange membrane), high ionic/H₂ and O₂ selectivity (low H₂ and O₂ permeability/crossover), low price, low area resistance to minimize efficiency loss resulting from ohmic polarization, high resistance to oxidizing and reducing conditions, being chemically inert at a wide pH range, high thermal stability together with high proton conductivity, and high mechanical strength (thickness, low swelling).

Recently newer cost-effective, high performance membrane materials for use with cell stack components for water electrolysis with a wide range of applications in renewable energy systems have been invented. While presumably effective for their intended purposes, it is known that hydrogen may migrate through the thin membrane and impact the effectiveness and efficiency of the cell. The H₂ crossover from the cathode stream to the anode stream also leads to safety concerns if the concentration of H₂ in O₂ reaches 2%.

Accordingly, it would be desirable to provide low cost, easily manufacturable membranes that reduce or eliminate the amount of hydrogen flowing across the membrane.

### BRIEF DESCRIPTION OF THE DRAWINGS

FIG. 1 is an illustration of one embodiment of a PEMWE cell.

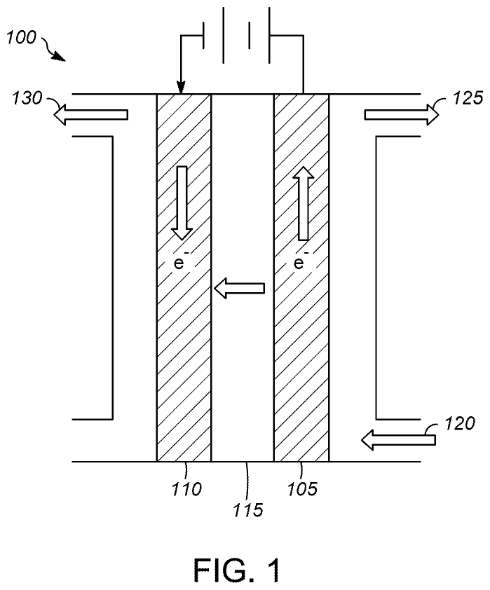

FIG. 2 is an illustration of one embodiment of a AEMWE cell.

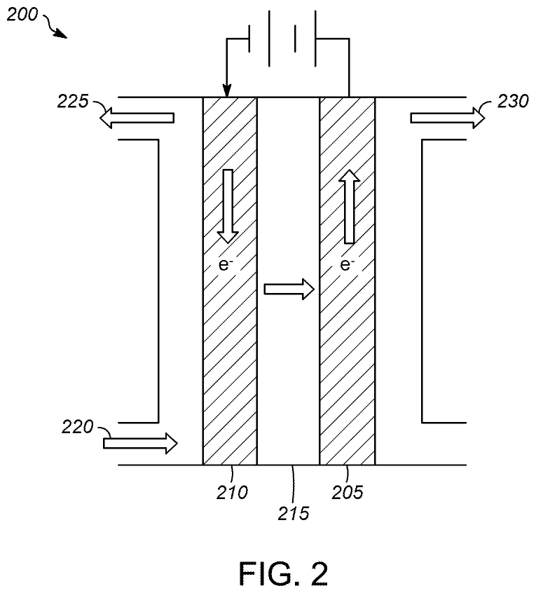

FIG. 3 is an illustration of one embodiment of a proton exchange membrane of the present invention comprising a reinforced membrane comprising a single layer membrane for PEMWE application.

FIG. 4 is an illustration of one embodiment of a proton exchange membrane of the present invention comprising a reinforced membrane comprising a multilayer membrane for PEMWE application.

FIG. 5 is a graph of polarization curves of a water electrolysis cell comprising of (a) PEM-RHPE-CCM and (b) N115-CCM at 80° C., atmospheric pressure.

### DESCRIPTION

The present invention relates to a new proton exchange membrane and a method of making the proton exchange membrane. The proton exchange membrane can be used for the preparation of catalyst coated membrane for water electrolysis to produce green H₂.

The proton exchange membrane comprises a reinforced membrane (e.g., less than or equal to 100 μm), a continuous nonporous H₂ recombination catalyst coating layer, and a continuous nonporous cross-linked polyelectrolyte multilayer coating. A radical scavenger may be included in the H₂ recombination catalyst coating layer to improve the chemical/electrochemical stability of the membrane. The continuous nonporous crosslinked polyelectrolyte multilayer coating is provided on the continuous nonporous H₂ recombination catalyst coating layer. Both the continuous nonporous crosslinked polyelectrolyte multilayer coating and the continuous nonporous H₂ recombination catalyst coating layer are water-insoluble. The continuous nonporous crosslinked polyelectrolyte multilayer coating and the H₂ recombination catalyst coating layer significantly reduce the permeation of hydrogen from the cathode side to the anode side through the reinforced membrane which leads to higher gas purity. It also addresses safety concerns compared to proton exchange membranes without the continuous nonporous H₂ recombination catalyst coating layer and the continuous nonporous crosslinked polyelectrolyte multilayers. Proton exchange membranes incorporating reinforced membranes (single layer or multilayer) provide significant improvement in the hydrogen production rate and the mechanic strength compared to non-reinforced membranes. The hydrogen in oxygen content at the anode of the water electrolyzer can be significantly reduced by incorporating a H₂ recombination catalyst coating layer. The permeating hydrogen and oxygen form water at the H₂ recombination catalyst coating layer, resulting in higher gas purity and resolving safety issues. The radical scavenger (when present) improves the chemical/electrochemical stability of the proton-exchange membrane.

One aspect of the present invention may be broadly characterized as a proton exchange membrane having: a reinforced membrane; a continuous nonporous H₂ recombination catalyst coating layer coated on a first surface of the reinforced membrane; and a continuous nonporous crosslinked polyelectrolyte multilayer coating on the continuous nonporous H₂ recombination catalyst coating layer.

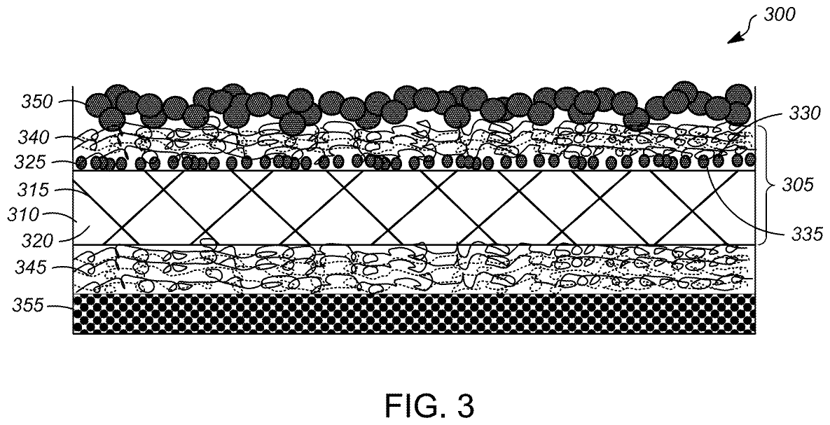

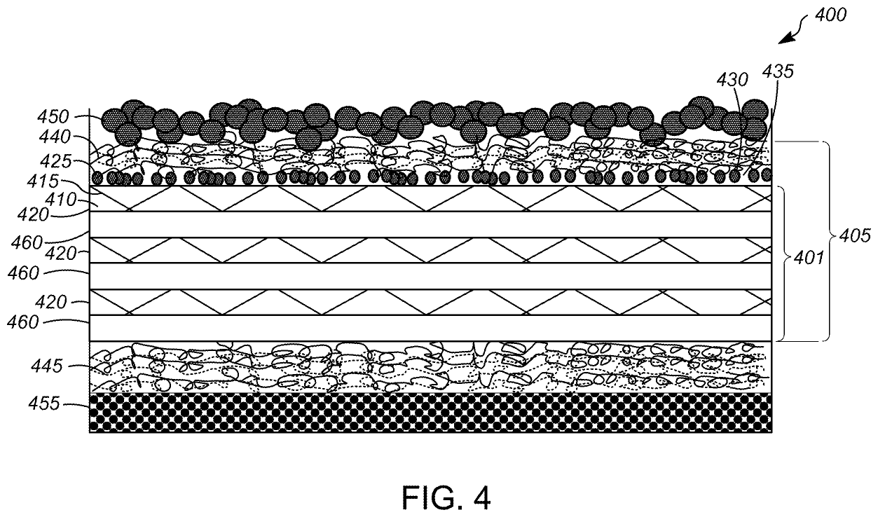

The reinforced membrane comprises a reinforcement material and a proton-conducting ionomer. The reinforced membrane may be a single layer membrane as shown in FIG. 3 or a multilayer membrane as shown in FIG. 4. The single layer membrane comprises a first reinforcement material and a first proton conducting ionomer. The multilayer membrane comprises at least one reinforced layer and at least one un-reinforced layer. The at least one reinforced layer comprises a second reinforcement material and a second proton conducting ionomer and the at least one un-reinforced layer comprises a third proton conducting ionomer. The second and third proton conducting ionomers can be the same or different.

Any suitable reinforcement material can be used. Suitable reinforcement materials include, but are not limited to, polytetrafluoroethylene (PTFE), polyphenylene sulfide (PPS), polyvinylidene difluoride (PVDF), polychlorotrifluoroethylene (PCTFE), polyether ether ketone (PEEK), polyimide (PI), polyetherimide (PEI), polybenzoxazole (PBO), polybenzimidazole (PBI), polysulfone (PSF), polyethersulfone (PES), polyaramid, polypropylene (PP), polyethylene (PE), co-PP-PE, or combinations thereof.

Any suitable proton conducting ionomer can be used for the reinforced membrane. Suitable proton conducting ionomers include, but are not limited to, a cation exchange polymer or a mixture of a cation exchange polymer and an inorganic filler comprising covalently bonded acidic functional groups. The cation exchange polymer comprises —SO₃⁻, —COO⁻, —PO₃²⁻, or —PO₃H⁻ cation exchange functional groups with negative ionic charges. The cation exchange polymer may be selected from, but is not limited to, a perfluorinated ionomer such as Nafion®, Aciplex®, and Aquivion®, a cross-linked perfluorinated cation exchange polymer, a partially fluorinated cation exchange polymer, a cross-linked partially fluorinated cation exchange polymer, a non-fluorinated hydrocarbon polymer, a cross-linked non-fluorinated hydrocarbon cation exchange polymer, or combinations thereof.

The reinforced membrane (single layer or multilayer) has a total thickness of about 100 μm or less, e.g., less than or equal to 100 μm, or less than or equal to 95 μm, or less than or equal to 90 μm, or less than or equal to 85 μm, or less than or equal to 80 μm, or less than or equal to 75 μm, or less than or equal to 70 μm, or less than or equal to 65 μm, or less than or equal to 60 μm, or less than or equal to 55 μm, or less than or equal to 50 μm, or less than or equal to 45 μm, or less than or equal to 40 μm, or less than or equal to 35 μm, or less than or equal to 30 μm, or less than or equal to 25 μm, or less than or equal to 20 μm, or less than or equal to 15 μm, or in the range of 10 to 100 μm, or 10 to 95 μm, or 10 to 90 μm, or 10 to 85 μm, or 10 to 80 μm, or 10 to 75 μm, or 10 to 70 μm, or 10 to 65 μm, or 10 to 60 μm, or 10 to 55 μm, or 10 to 50 μm, or 10 to 45 μm, or 10 to 40 μm, or 10 to 35 μm, or 10 to 30 μm, or 10 to 25 μm, or 10 to 20 μm, or 10 to 15 μm,

The continuous nonporous H₂ recombination catalyst coating layer comprises a mixture of a hydrogen (H₂) recombination catalyst and a proton conducting ionomer. Any suitable hydrogen recombination catalyst can be used. Suitable hydrogen recombination catalysts include, but are not limited to, comprises Pt, Pt supported on carbon or silica, PtCo, PtCo supported on carbon or silica, Pd, Pd supported on carbon or silica, PdCo, PdCo supported on carbon or silica, or mixtures thereof.

The weight ratio of the hydrogen recombination catalyst to the proton conducting ionomer in the continuous nonporous H₂ recombination catalyst coating layer is in a range of 1:500 to 1:20, or 1:200 to 1:50, or 1:100 to 1:50.

The continuous nonporous H₂ recombination catalyst coating layer typically has a thickness in the range of 1 micrometer to 50 micrometers, or 1 to 45, or 1 to 40, or 1 to 35, or 1 to 30, or 1 to 25, or 1 to 20, or 1 to 15, or 5 to 50, or 5 to 45, or 5 to 40, or 5 to 35, or 5 to 30, or 5 to 25, or 5 to 20, or 5 to 15, or 10 to 50, or 10 to 45, or 10 to 40, or 10 to 35, or 10 to 30, or 10 to 25, or 10 to 20, or 10 to 15.

The H₂ recombination catalyst coating layer can optionally include radical scavengers to improve the chemical/electrochemical stability of the proton exchange membrane. The radical scavengers may include, but are not limited to, inorganic nanoparticles comprise CeO₂, Ce(OH)₄, CeO₂/ZrO₂, Ce(OH)₄/ZrO₂, ZrO₂, silica gel, precipitated silica, fumed silica, colloidal silica, or mixtures thereof. The inorganic nanoparticles have a size in a range of 1 nanometer to 500 nanometers, or 1 to 400, or 1 to 300, or 1 to 250, or 1 to 200, or 1 to 150, or 1 to 100, or 1 to 50, or 5 to 500, or 5 to 400, or 5 to 300, or 5 to 250, or 5 to 200, or 5 to 150, or 5 to 100, or 5 to 50, or 10 to 500, or 11 to 400, or 10 to 300, or 10 to 250, or 10 to 200, or 10 to 150, or 10 to 100, or 10 to 50.

The proton conducting ionomer in the continuous nonporous H₂ recombination catalyst coating layer comprises a proton conducting ionomer or a cross-linked proton conducting ionomer comprising repeat units of both electrically neutral repeating units and a fraction of ionized functional groups such as —SO₃⁻, —COO−, —PO₃²⁻, —PO₃H⁻, —C₆H₄O⁻, or —O₄B⁻. The proton conducting ionomer contains high water affinity polar or charged functional groups such as —SO₃−, —COO⁻ or —PO₃²⁻ group.

In the present invention, the proton conducting ionomer, cation exchange polymer, and proton exchange polymer are interchangeable.

Suitable proton conducting ionomers include, but are not limited to, a cation exchange polymer or a mixture of a cation exchange polymer and an inorganic filler comprising covalently bonded acidic functional groups. The cation exchange polymer comprises —SO₃−, —COO⁻, —PO₃²⁻, or —PO₃H⁻ cation exchange functional groups with negative ionic charges. The cation exchange polymer may be selected from, but is not limited to, a perfluorinated ionomer such as Nafion®, Aciplex®, and Aquivion®, a cross-linked perfluorinated cation exchange polymer, a partially fluorinated cation exchange polymer, a cross-linked partially fluorinated cation exchange polymer, a non-fluorinated hydrocarbon polymer, a cross-linked non-fluorinated hydrocarbon cation exchange polymer, or combinations thereof.

The cation exchange polymer may be a perfluorinated sulfonic acid-based polymer, a perfluorinated carboxylic acid polymer, a sulfonated aromatic hydrocarbon polymer, a cross-linked sulfonated aromatic hydrocarbon polymer, or combinations thereof. The cation exchange polymer may be a copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro (2,2-dimethyl-1,3-dioxole), a copolymer of perfluoro-5-oxa-6-heptene-sulfonic acid and perfluoro (2,2-dimethyl-1,3-dioxole), a copolymer of perfluoro-4-oxa-5-hexene-sulfonic acid and perfluoro (2,2-dimethyl-1,3-dioxole), a copolymer of perfluoro-3-oxa-4-pentene-sulfonic acid and perfluoro (2,2-dimethyl-1,3-dioxole), a copolymer of perfluoro-3,6-dioxa-4-methyl-7-octene-sulfonic acid and perfluoro (2-methylene-4-methyl-1,3-dioxolane), a copolymer of perfluoro-5-oxa-6-heptene-sulfonic acid and perfluoro (2-methylene-4-methyl-1,3-dioxolane), a copolymer of perfluoro-4-oxa-5-hexene-sulfonic acid and perfluoro (2-methylene-4-methyl-1,3-dioxolane), a copolymer of perfluoro-3-oxa-4-pentene-sulfonic acid and perfluoro (2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, a copolymer of perfluoro-3-oxa-4-pentene-sulfonic acid and 2,2,4-trifluoro-5-trifluoromethoxy-1,3-dioxole, sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, cross-linked sulfonated poly(vinyl toluene), or combinations thereof.

The reinforced membrane (single layer or multilayer) comprises a cation exchange polymer or a mixture of a cation exchange polymer and an inorganic filler comprising covalently bonded acidic functional groups. The cation exchange polymer may comprise —SO₃⁻, —COO⁻, —PO₃²⁻, or —PO₃H⁻ cation exchange functional groups with negative ionic charges. The cation exchange polymer may be selected from, but is not limited to, a perfluorinated ionomer such as Nafion®, Aciplex®, or Aquivion®, a cross-linked perfluorinated cation exchange polymer, a partially fluorinated polymer, a cross-linked partially fluorinated proton exchange polymer, a non-fluorinated hydrocarbon polymer, a cross-linked non-fluorinated hydrocarbon proton exchange polymer, or combinations thereof. The reinforced proton exchange membrane single layer or multilayer has high mechanical strength, good chemical and thermal stability, and good proton conductivity.

The reinforced membrane comprising the single layer membrane may be the composite proton conductive membrane described in U.S. patent application Ser. No. 17/162,421, filed on Jan. 29, 2021, entitled Composite Proton Conductive Membranes, which is incorporated herein by reference in its entirety. That application disclosed a new type of composite proton conductive membrane comprising an inorganic filler having covalently bonded acidic functional groups and a high surface area of at least 150 m²/g, and a water insoluble ionically conductive polymer. The deposition of the polyelectrolyte multilayer coating on the composite proton conductive membrane resulted in reduced membrane swelling, significantly reduced H₂ and O₂ crossover, and enhanced proton conductivity compared to the composite proton conductive membrane without the polyelectrolyte multilayer coating.

The inorganic filler comprising covalently bonded acidic functional groups in the reinforced proton exchange membrane single layer or multilayermay be selected from, but is not limited to, silica gel, precipitated silica, fumed silica, colloidal silica, alumina, silica-alumina, zirconium oxide, molecular sieve, metal-organic framework, zeolitic imidazolate framework, covalent organic framework, or a combination thereof, and wherein the filler may comprise both covalently bonded acidic functional groups and a high surface area of 150 m²/g or higher, or 300 m²/g or higher, or 400 m²/g or higher. Molecular sieves have framework structures which may be characterized by distinctive wide-angle X-ray diffraction patterns. Zeolites are a subclass of molecular sieves based on an aluminosilicate composition. Non-zeolitic molecular sieves are based on other compositions such as aluminophosphates, silico-aluminophosphates, and silica. Molecular sieves can have different chemical compositions and different framework structure. The molecular sieves can be microporous or mesoporous molecular sieves and need to be stable in aqueous solution under pH of less than 6. The acidic functional groups covalently bonded to the inorganic fillers may be selected from, but are not limited to, —H₂PO₃, —R—H₂PO₃, —SO₃H, —R—SO₃H, —COOH, —R—COOH, —C₆H₅OH, —R—C₆H₅OH, or a combination thereof, wherein R represents a linear alkyl group, a branched alkyl group, a cycloalkyl group, an organoamino group, an acid group-substituted organoamino group, or an aryl group and the number of carbon atoms in these groups is preferably 1 to 20, more preferably 1 to 10. The inorganic fillers may be in the form of, but are not limited to, particles, fine beads, thin plates, rods, or fibers. The size of the inorganic filler is in a range of about 2 nm to about 200 μm, or in a range of about 10 nm to about 100 μm, or in a range of about 50 nm to about 80 μm. In some embodiments, the inorganic filler is aminopropyl-N,N-bis(methyl phosphonic acid)-functionalized silica gel such as SilicaMetS® AMPA, aminopropyl-N,N-bis(methyl phosphonic acid)-functionalized fumed silica, n-propyl phosphonic acid-functionalized silica gel, n-propyl phosphonic acid-functionalized fumed silica, p-toluenesulfonic acid-functionalized silica gel, p-toluenesulfonic acid-functionalized fumed silica, 4-ethylbenzenesulfonic acid-functionalized silica gel such as SilicaBond® Tosic Acid, 4-ethylbenzenesulfonic acid-functionalized fumed silica, n-propyl sulfonic acid-functionalized silica gel, n-propyl sulfonic acid-functionalized fumed silica, or combinations thereof.

The continuous nonporous cross-linked polyelectrolyte multilayer coating comprises alternating layers of a polycation polymer and a polyanion polymer. The polycation polymer layer is deposited on and is in contact with the continuous nonporous H₂ recombination catalyst coating layer. There can be one, two, three, four, five, or more sets of alternating polycation polymer and polyanion polymer layers on the surface of the cation exchange membrane. The top layer of the polyelectrolyte multilayer coating can be either a polycation polymer layer or a polyanion polymer layer.

The polyelectrolyte multilayer coating typically has a thickness less than the thickness of the reinforced proton exchange membrane. The thickness of the polyelectrolyte multilayer coating is typically in a range of 1 nanometer to 200 nanometers, or 1 to 150, or 1 to 100, or 1 to 50, or 1 to 20, or 2 to 200, or 2 to 150, or 2 to 100, or 2 to 50, or 2 to 20, or 5 to 200, or 5 to 150, or 5 to 100, or 5 to 50, or 5 to 20.

There can be a second polyelectrolyte multilayer coating on the second surface of the reinforced membrane.

The polyelectrolyte multilayer coating may be formed using a layer-by-layer self-assembly method. The layer-by-layer self-assembly may be achieved by adsorption, electrostatic interactions, covalent bonds, hydrogen bonds, van der Waals forces, hydrophobic interactions, or combinations thereof, for example. The methods for the formation of polyelectrolyte multilayer coating via layer-by-layer self-assembly may be selected from, but are not limited to, dip coating, spray deposition, centrifugal deposition, electrodeposition, meniscus/slot die coating, brushing, roller coating, metering rod/Meyer bar coating, knife casting, and the like.

The choice of the fabrication method depends on the polycation and polyanion to be assembled, the time required for the layer-by-layer self-assembly, and the shape of the membrane that the polyelectrolyte multilayer coating will be deposited on. The first polyelectrolyte layer is formed by the adsorption (for example) of a polycation or polyanion on the surface of the continuous nonporous H₂ recombination catalyst coating layer. Subsequently, the second layer of the polyelectrolyte with charges opposite from the first layer of the polyelectrolyte is deposited on the first layer of the polyelectrolyte to form one set of alternating layers on the continuous nonporous H₂ recombination catalyst coating layer. The increase in polyelectrolyte multilayer thickness depends on the number of layers deposited and can be either linear or non-linear. Several parameters, such as ionic strength, pH, temperature, polyelectrolyte structure, concentration, and charge density, can be adjusted during the layer-by-layer self-assembly process. The oppositely changed polyelectrolyte layers are deposited on the surface of the continuous nonporous H₂ recombination catalyst coating layer. The polyelectrolyte multilayers have ionically cross-linked structure and are insoluble in water and thermally and chemically stable.

The first layer deposited on the surface of the continuous nonporous H₂ recombination catalyst coating layer (and the second surface of the reinforced proton exchange membrane possessing negative ionic charges if present) should be a polycation polymer layer having positive ionic charges, opposite from those on the continuous nonporous H₂ recombination catalyst coating layer (and the reinforced proton exchange membrane layer), which leads to the formation of a stable coating as the first part of the first polyelectrolyte bilayer via electrostatic interactions between the cation exchange polymer on the surface of the continuous nonporous H₂ recombination catalyst coating layer and the polycation deposited on the surface of the continuous nonporous H₂ recombination catalyst coating layer. A polyanion polymer with opposite charges is then deposited on the surface of the first polycation polymer coating layer via electrostatic interactions to form the second part of the first polyelectrolyte bilayer. Polyelectrolyte multilayers of (polycation-polyanion) n can be formed following the same alternating deposition process. The thickness of each layer of the polyanion or polycation is less than 50 nm, or less than 20 nm, or less than 10 nm, or less than 5 nm. The polyanion polymer in the polyelectrolyte multilayers has negative charges and can be the same or different from the cation exchange polymer in the continuous nonporous H₂ recombination catalyst coating layer and the reinforced proton exchange membrane single layer or multilayer, but the polyanion polymer cannot be the first polyelectrolyte layer deposited on the surface of the continuous nonporous H₂ recombination catalyst coating layer having negative charges. The polyanion polymer suitable for the preparation of the polyelectrolyte multilayer has similar or higher proton conductivity than the reinforced proton exchange membrane and has similar or lower H₂ and O₂ permeabilities than the reinforced proton exchange membrane. However, the polyanion polymer and the polycation polymer may be soluble in aqueous solutions, which makes the membranes prepared from either the polyanion polymer or polyanion polymer unsuitable for water electrolysis or fuel cell applications. Therefore, it is important to form polyelectrolyte multilayers comprising ionically cross-linked alternating polycations and polyanions. The polyelectrolyte multilayers formed via layer-by-layer self-assembly are not only insoluble in water and thermally and chemically stable, but also have significantly reduced swelling and H₂ and O₂ crossover, and enhanced proton conductivity compared to the reinforced proton exchange membrane layer for water electrolysis or fuel cell applications.

The polycation polymers suitable for the preparation of the polyelectrolyte multilayer coating include, but are not limited to protonated chitosan; an amine based linear, hyperbranched, or dendritic polycation polymer selected from the group consisting of polybiguanide, quaternary ammonium polyethyleninine, quaternary arrrnmonium polypropylenirnine, quaternary ammoniunm polyamidoamine (PAMAM), poly(vinylamine hydrochloride) (PVH), poly(allylamine hydrochloride) (PAH), poly(amidoamine hydrochloride), poly(N-isopropylallylamine hydrochloride), poly(N-tert-butylallylamine hydrochloride), poly(N-1,2-dimethylpropylallylamine hydrochloride), poly(N-methylallylamine hydrochloride), poly(N,N-dimethylallylamine hydrochloride), poly(2-vinylpiperidine hydrochloride), poly(4-vinylpiperidine hydrochloride), poly(4-vinylpyridine hydrochloride), poly(diallyldimethylammonium chloride), poly(acrylamide-co-diallyldimethylammonium chloride), poly(diallyl methyl amine hydrochloride), a copolymer of 2-propen-1-amine-hydrochloride with N-2-propenyl-2-propen-1-aminehydrochloride, poly(N-alkyl-4-vinylpyridinium) salt, polylysine, polyornithine, polyarginine, poly(ethylene oxide)-block-poly(vinyl benzyl trimethylammonium chloride), poly(ethylene oxide)-block-poly(1-lysine), poly(2-methacryloyloxyethyl phosphorylcholine methacrylate)-block-poly(vinyl benzyl trimethylammonium chloride), poly[2-(dimethylamino)-ethyl methacrylate, poly[3-(dimethylamino)-propyl methacrylate], poly[2-(dimethylamino)-ethyl methacrylamide], poly[3-(dimethylamino) propyl methacrylamide], poly(2-(trimethylamino)ethyl methacrylate chloride], poly[2-(diethylamino)ethyl methacrylate], poly[2-(dimethylamino)ethyl acrylate], or combinations thereof.

The polyanion polymers suitable for the preparation of the polyelectrolyte multilayer coating include but, are not limited to, a sulfonated hydrocarbon polymer, poly(acrylic acid), poly(sodium phosphate), or a negatively charged polysaccharide polyanion polymer, or combinations thereof. Suitable sulfonated hydrocarbon polymers include, but are not limited to, sulfonated poly(ether ether ketone), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated polystyrene, sulfonated poly(vinyl toluene), poly(acrylic acid), poly(vinylsulfonic acid sodium), poly(sodium phosphate), or combinations thereof. Suitable negatively charged polysaccharide polyanion polymers include, but are not limited to, sodium alginate, potassium alginate, calcium alginate, ammonium alginate, alginic acid, sodium hyaluronate, potassium hyaluronate, calcium hyaluronate, ammonium hyaluronate, hyaluronic acid, κ-carrageenan, λ-carrageenan, ι-carrageenan, carboxymethyl curdlan, sodium carboxymethyl curdlan, potassium carboxymethyl curdlan, calcium carboxymethyl curdlan, ammonium carboxymethyl curdlan, carboxymethyl cellulose, sodium carboxymethyl cellulose, potassium carboxymethyl cellulose, calcium carboxymethyl cellulose, ammonium carboxymethyl cellulose, or combinations thereof.

Another aspect of the present invention may be broadly characterized as a proton exchange membrane comprising: a reinforced membrane (single layer or multilayer) having a first surface and a second surface; a continuous nonporous H₂ recombination catalyst coating layer having a first surface and a second surface, the first surface of the continuous nonporous H₂ recombination catalyst coating layer on the first surface of the reinforced membrane, the continuous nonporous H₂ recombination catalyst coating layer comprising a mixture of a H₂ recombination catalyst, a proton conducting ionomer, and optionally a radical scavenger; and a continuous nonporous cross-linked polyelectrolyte multilayer coating on the second surface of the coating layer, the polyelectrolyte multilayer coating comprising alternating layers of a polycation polymer and a polyanion polymer, and wherein the polycation polymer layer is in contact with the continuous nonporous H₂ recombination catalyst coating layer; an anode on a second surface of the continuous nonporous cross-linked polyelectrolyte multilayer coating; and a cathode on the second surface of the reinforced proton exchange membrane; or a cathode on a second surface of a second continuous nonporous cross-linked polyelectrolyte multilayer coating on the second surface of the reinforced proton exchange membrane.

Any suitable anode and cathode materials can be used. Suitable anodes include, but are not limited to, iridium, platinum, ruthenium, osmium, rhodium, palladium, tin, tungsten, vanadium, cobalt, silver, gold, copper, nickel, molybdenum, iron, chromium, alloys thereof, oxides thereof, carbides thereof, phosphides thereof, or combinations thereof. Suitable cathodes include, but are not limited to, platinum, ruthenium, osmium, rhodium, palladium, tin, tungsten, vanadium, cobalt, silver, gold, nickel, molybdenum, iron, copper, chromium, alloys thereof, oxides thereof, carbides thereof, phosphides thereof, or combinations thereof.

Another aspect of the present invention may be characterized broadly as providing a method for preparing a proton exchange membrane comprising applying a continuous nonporous H₂ recombination catalyst coating layer directly on a first surface of a reinforced membrane, the continuous nonporous H₂ recombination catalyst coating layer comprising a mixture of a H₂ recombination catalyst, a proton conducting ionomer, and optionally a radical scavenger; and applying a continuous nonporous cross-linked polyelectrolyte multilayer coating directly on a surface of the continuous nonporous H₂ recombination catalyst coating layer, the polyelectrolyte multilayer coating comprising alternating layers of a polycation polymer and a polyanion polymer, wherein the polycation polymer layer is in contact with the continuous nonporous H₂ recombination catalyst coating layer.

The method may include applying a second continuous cross-linked polyelectrolyte multilayer coating directly on a second surface of the reinforced membrane, the polyelectrolyte multilayer coating comprising alternating layers of a polycation polymer and a polyanion polymer, wherein the polycation polymer layer is in contact with the reinforced proton exchange membrane.

The method may also include applying an anode on a second surface of the continuous nonporous cross-linked polyelectrolyte multilayer coating, and applying a cathode to a second surface of the reinforced membrane; or applying an anode on a second surface of the continuous nonporous cross-linked polyelectrolyte multilayer coating, applying a second continuous nonporous cross-linked polyelectrolyte multilayer coating on a second surface of the reinforced membrane, and applying a cathode to a second surface of the second continuous nonporous cross-linked polyelectrolyte multilayer coating.

FIG. 3 illustrates one embodiment of catalyst coated membrane 300 incorporating the proton exchange membrane 305. The proton exchange membrane 305 includes the reinforced membrane 310 comprising a single layer, which includes a reinforcement material 315 and a proton conducting ionomer 320.

There is a continuous nonporous H₂ recombination catalyst coating layer 325 on the surface of the reinforced membrane 310. The continuous nonporous H₂ recombination catalyst coating layer 325 comprises a mixture of a hydrogen recombination catalyst 330 and a proton conducting ionomer 335.

There is a continuous nonporous cross-linked polyelectrolyte multilayer coating 340 on the surface of the continuous nonporous H₂ recombination catalyst coating layer 325. The continuous nonporous cross-linked polyelectrolyte multilayer coating 340 comprises alternating layers of a polycation polymer and a polyanion polymer, and the polycation polymer layer is in contact with the continuous nonporous H₂ recombination catalyst coating layer 325. There can optionally be a second continuous nonporous cross-linked polyelectrolyte multilayer coating 345 on the opposite side of the reinforced membrane 310.

There is an anode 350 next to the continuous nonporous cross-linked polyelectrolyte multilayer coating 340, and a cathode 355 next to the second continuous nonporous cross-linked polyelectrolyte multilayer coating 345 (as shown) or next to the reinforced membrane 310 (if the second continuous nonporous cross-linked polyelectrolyte multilayer coating 345 is not present).

FIG. 4 illustrates one embodiment of catalyst coated membrane 400 incorporating the proton exchange membrane 405. The proton exchange membrane 405 includes a multilayer membrane 401, which comprises three alternating thin layers of reinforced membrane 420 and non-reinforced membrane 460. The thin layer of reinforced membrane 420 includes reinforcement material 415 and a proton conducting ionomer 410. The thin layer of non-reinforced membrane 460 includes a proton conducting ionomer 410.

There is a continuous nonporous H₂ recombination catalyst coating layer 425 on the surface of the multilayer membrane 401. The continuous nonporous H₂ recombination catalyst coating layer 425 comprises a mixture of a hydrogen recombination catalyst 430 and a proton conducting ionomer 435. The continuous nonporous H₂ recombination catalyst coating layer 425 can be in contact with the thin layer of reinforced membrane 420 as shown in FIG. 4 or can be in contact with the thin layer of non-reinforced membrane 460.

There is a continuous nonporous cross-linked polyelectrolyte multilayer coating 440 on the surface of the continuous nonporous H₂ recombination catalyst coating layer 425. The continuous nonporous cross-linked polyelectrolyte multilayer coating 440 comprises alternating layers of a polycation polymer and a polyanion polymer, and the polycation polymer layer is in contact with the continuous nonporous H₂ recombination catalyst coating layer 425. There can optionally be a second continuous nonporous cross-linked polyelectrolyte multilayer coating 445 on the opposite side of the multilayer membrane 401.

There is an anode 450 next to the continuous nonporous cross-linked polyelectrolyte multilayer coating 440, and a cathode 455 next to the second continuous nonporous cross-linked polyelectrolyte multilayer coating 445 (as shown) or next to the multilayer membrane 401 (if the second continuous nonporous cross-linked polyelectrolyte multilayer coating 445 is not present).

### EXAMPLES

### Example 1: Fabrication of a Proton Exchange Membrane Comprising a Reinforced Nafion™ XL Base Membrane, a H₂ Recombination Layer, and a Polyelectrolyte Coating Layer (Abbreviated as PEM-RHPE)

A mixture containing nanosized CeO₂, Pt black catalyst, Nafion™ ionomer suspension, water, and EtOH was sonicated by a probe in an ice bath to form a hydrogen recombination ink dispersion. A thin layer of the hydrogen recombination ink was applied to one surface of the reinforced Nafion™ XL base membrane purchased from Chemours using a Mayer rod coating method. The coated membrane was dried for 30 mins at 60° C. in an oven to evaporate all the solvents and solidify the hydrogen recombination layer. Afterwards, the membrane was annealed for 1 h at 100° C. to form a Pt/CeO₂/Nafion™ coated Nafion™ membrane. A poly(allylamine hydrochloride) (PAH) polycation solution was prepared by dissolving NaCl and PAH in deionized (DI) H₂O. A sulfonated poly(ether ether ketone) (SPEEK) polyanion aqueous solution was prepared by dissolving NaCl and SPEEK in DI H₂O at 80° C. The surface of the Pt/CeO₂/Nafion™ composite coating layer on the Pt/CeO₂/Nafion™ coated Nafion™ XL membrane was immersed in the PAH polycation solution for 5 min, and the membrane was rinsed with DI H₂O 3 times. The membrane was then immersed in the SPEEK polyanion solution for 5 min. The membrane was rinsed with DI H₂O 3 times and one ionically cross-linked PAH/SPEEK polyelectrolyte bilayer was deposited on the surface of the Pt/CeO₂/Nafion™ composite coating layer. This process was repeated to deposit 3 sets of PAH/SPEEK polyelectrolyte bilayers on the surface of the Pt/CeO₂/Nafion™ coating layer and the PAH/SPEEK polyelectrolyte bilayers were not coated on the second surface of the reinforced Nafion™ XL base membrane. The coated membrane was dried for 30 min at 60° C. to form PEM-RHPE membrane.

### Example 2: Fabrication of a Catalyst-Coated Proton Exchange Membrane Using PEM-RHPE Membrane (Abbreviated as PEM-RHPE-CCM)

An anode ink comprising an IrO₂ oxygen evolution reaction (OER) catalyst, water, an additive solution of poly(3,4-ethylenedioxythiophene) (PEDOT), EtOH, and a Nafion™ ionomer suspension was coated on the surface of the PAH/SPEEK polyelectrolyte bilayers of the PEM-RHPE membrane using the Mayer rod coating method. After the anode coating, the anode catalyst-coated membrane was dried for 30 min at 60° C. The anode IrO₂ loading was about 1.0 mg/cm². Then, a cathode ink comprising Pt/C catalyst, water, a PEDOT solution, EtOH, and a Nafion™ ionomer suspension was coated on a second surface of the PEM-RHPE membrane using the Mayer rod coating method to form a three-layer catalyst-coated membrane (CCM) PEM-RHPE-CCM. The PEM-RHPE-CCM was dried for 30 min at 60° C. and then for another 2 h at 100° C. The cathode Pt loading was about 0.2 mg/cm². The PEM-RHPE-CCM was soaked in 0.1M H₂SO₄ for 24 h at room temperature, rinsed with ultra-pure water, and finally air dried for 16 h at room temperature. After drying, the PEM-RHPE-CCM was hot-pressed to form the final PEM-RHPE-CCM.

### Comparative Example 1: Fabrication of a Catalyst-Coated Proton Exchange Membrane Using Nafion™ 115 Membrane (Abbreviated as N115-CCM)

An anode ink comprising an IrO₂ catalyst, water, an additive solution of poly(3,4-ethylenedioxythiophene) (PEDOT), EtOH, and Nafion™ ionomer suspension was spray coated on one surface of the Nafion™ 115 membrane at 80° C. The anode IrO₂ loading was about 1.0 mg/cm². Then, a cathode ink comprising Pt/C catalyst, water, a PEDOT solution, EtOH, and a Nafion™ ionomer suspension was spray coated on the second surface of the Nafion™ 115 membrane at 80° C. to form a three-layer catalyst-coated membrane N115-CCM. The cathode Pt loading was about 0.2 mg/cm². The N115-CCM was soaked in 0.1M H₂SO₄ for 24 h at room temperature, rinsed with ultra-pure water, and finally air dried for 16 h at room temperature.

### Example 3: In-Plane H⁺ Conductivity Evaluation of PEM-RHPE Membrane

The PEM-RHPE membrane made in Example 1 was cut into a strip with 1 cm width and put in a glass bottle. It was soaked in a 1M HCl solution for 16 h at 80° C. Then the membrane was soaked in ultra-pure water to remove HCl from the membrane. The membrane was rinsed with ultra-pure water three times and then installed in a testing cell with three Pt electrodes and soaked in fresh ultra-pure water at room temperature. The testing cell was connected to a potentiostat (Gamry Reference 600+), an impedance analyzer for electrochemical impedance spectroscopy (EIS). A galvanostatic EIS measurement in the range from 100 kHz to 10 Hz with a 10 points/decade rate was conducted. The resistance was extracted from the Nyquist plot and the in-plane H⁺ conductivity was calculated. The in-plane H⁺ conductivity of the PEM-RHPE obtained from this measurement is 116 mS/cm.

### Example 4: Water Electrolysis Performance Evaluation of PEM-RHPE-CCM and N115-CCM

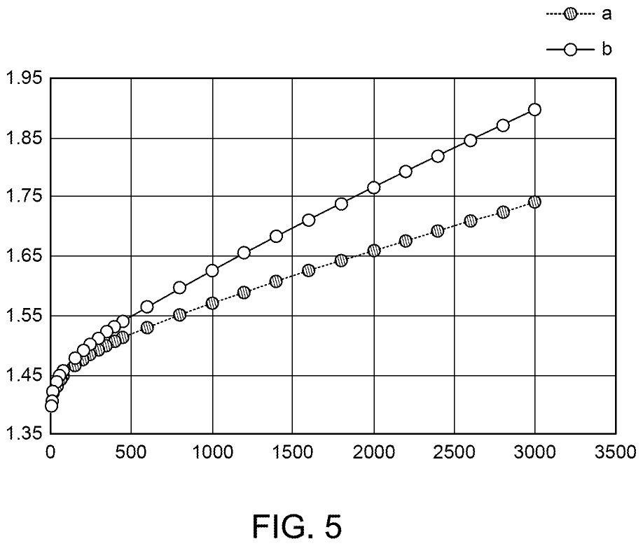

The water electrolysis performance of N115-CCM made in Comparative Example 1 and PEM-RHPE-CCM made in Example 2 were evaluated using a single water electrolysis cell at atmospheric pressure in a Scribner unit. The CCM was sandwiched between a carbon paper and a Pt-coated titanium porous transport layers (PTL) to form the catalyst-coated membrane electrode assembly. Then, the catalyst-coated membrane electrode assembly was installed in a Scribner test cell with an active catalyst coating area of 5 cm². A water electrolysis test station (Scribner 600 electrolyzer test system) was used to evaluate the water electrolysis performance of N115-CCM and PEM-RHPE-CCM. PTLs and compression factors, defined as ratio between sealing gasket thickness and PTL thickness, were identical between these assemblies. The test station included an integrated power supply, a potentiostat for EIS and high-frequency resistance (HFR). The testing was conducted at 80° C. under 15 psig (103 kPa) pressure with an ultra-pure water feed at the anode side of the test cell with a flow rate of 100 m/min. The polarization curves are shown in FIG. 5. The H₂ concentration in O₂ in the anode gas stream was measured by gas chromatography (GC). It can be observed from the polarization curves in FIG. 5 that the PEM-RHPE-CCM showed much higher current density than the N115-CCM at 1.7 V cell voltage, demonstrating that the water electrolyzer comprising PEM-RHPE-CCM has higher hydrogen production rate than that comprising N115-CCM. In addition, the PEM-RHPE-CCM showed lower H₂ crossover than N115-CCM. A low H₂ concentration in O₂ of 0.06% in the anode gas stream at 2 A/cm² current density was obtained for PEM-RHPE-CCM compared to a H₂ concentration in O₂ of 0.71% in the anode gas stream at 2 A/cm² current density for N115-CCM.

### SPECIFIC EMBODIMENTS

While the following is described in conjunction with specific embodiments, it will be understood that this description is intended to illustrate and not limit the scope of the preceding description and the appended claims.

A first embodiment of the invention is a composition comprising a reinforced membrane having a first surface and a second surface, the reinforced membrane having a thickness of less than or equal to 100 μm; a continuous nonporous hydrogen recombination catalyst coating layer having a first surface and a second surface, the first surface of the continuous hydrogen recombination catalyst coating layer on the first surface of the reinforced membrane, the continuous nonporous hydrogen recombination catalyst coating layer comprising a mixture of a hydrogen recombination catalyst and a proton conducting ionomer; and a continuous nonporous cross-linked polyelectrolyte multilayer coating on the second surface of the continuous nonporous hydrogen recombination catalyst coating layer, the nonporous cross-linked polyelectrolyte multilayer coating comprising alternating layers of a polycation polymer and a polyanion polymer, and wherein the polycation polymer layer is in contact with the continuous nonporous hydrogen recombination catalyst coating layer. An embodiment of the invention is one, any or all of prior embodiments in this paragraph up through the first embodiment in this paragraph wherein the reinforced membrane comprises a single layer membrane comprising a first reinforcement material and a first proton conducting ionomer or a multilayer membrane comprising at least one reinforced layer and at least one un-reinforced layer, wherein the at least one reinforced layer comprises a second reinforcement material and a second proton conducting ionomer and the at least one un-reinforced layer comprises a third proton conducting ionomer. An embodiment of the invention is one, any or all of prior embodiments in this paragraph up through the first embodiment in this paragraph wherein the first proton conducting ionomer, or the second proton conducting ionomer, or the third proton conducting ionomer, or combinations thereof comprises a perfluorosulfonic acid (PFSA) polymer selected from copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, or a copolymer of perfluoro-3-oxa-4-pentene-sulfonic acid and 2,2,4-trifluoro-5-trifluoromethoxy-1,3-dioxole, a non-PFSA polymer selected from sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, or cross-linked sulfonated poly(vinyl toluene), or combinations thereof. An embodiment of the invention is one, any or all of prior embodiments in this paragraph up through the first embodiment in this paragraph wherein the first reinforcement material, or the second reinforcement material, or both comprises polytetrafluoroethylene (PTFE), polyphenylene sulfide (PPS), polyvinylidene difluoride (PVDF), polychlorotrifluoroethylene (PCTFE), polyether ether ketone (PEEK), polyimide (PI), polyetherimide (PEI), polybenzoxazole (PBO), polybenzimidazole (PBI), polysulfone (PSF), polyethersulfone (PES), polyaramid, polypropylene (PP), polyethylene (PE), co-PP-PE, or combinations thereof. An embodiment of the invention is one, any or all of prior embodiments in this paragraph up through the first embodiment in this paragraph wherein the thickness of the reinforced membrane is in a range of 10 to 90 μm. An embodiment of the invention is one, any or all of prior embodiments in this paragraph up through the first embodiment in this paragraph wherein the hydrogen recombination catalyst comprises Pt, Pt supported on carbon or silica, PtCo, PtCo supported on carbon or silica, Pd, Pd supported on carbon or silica, PdCo, PdCo supported on carbon or silica, or mixtures thereof. An embodiment of the invention is one, any or all of prior embodiments in this paragraph up through the first embodiment in this paragraph wherein the proton conducting ionomer in the continuous nonporous hydrogen recombination catalyst coating layer comprises a perfluorosulfonic acid (PFSA) polymer selected from copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, or a copolymer of perfluoro-3-oxa-4-pentene-sulfonic acid and 2,2,4-trifluoro-5-trifluoromethoxy-1,3-dioxole, a non-PFSA polymer selected from sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, or cross-linked sulfonated poly(vinyl toluene), or combinations thereof. An embodiment of the invention is one, any or all of prior embodiments in this paragraph up through the first embodiment in this paragraph wherein the continuous nonporous hydrogen recombination catalyst coating layer further comprises a radical scavenger. An embodiment of the invention is one, any or all of prior embodiments in this paragraph up through the first embodiment in this paragraph wherein the radical scavenger comprises CeO₂, Ce(OH)₄, CeO₂/ZrO₂, Ce(OH)₄/ZrO₂, or mixtures thereof. An embodiment of the invention is one, any or all of prior embodiments in this paragraph up through the first embodiment in this paragraph further comprising a second continuous nonporous polyelectrolyte multilayer coating on the second surface of the reinforced membrane. An embodiment of the invention is one, any or all of prior embodiments in this paragraph up through the first embodiment in this paragraph wherein the continuous nonporous cross-linked polyelectrolyte multilayer coating comprises at least two sets of alternating layers of the polycation polymer and the polyanion polymer. An embodiment of the invention is one, any or all of prior embodiments in this paragraph up through the first embodiment in this paragraph wherein a ratio of the proton conducting ionomer to the hydrogen recombination catalyst is in a range of 5001 to 201.

A second embodiment of the invention is an apparatus comprising a proton exchange membrane comprising; a reinforced membrane having a first surface and a second surface, the reinforced membrane having a thickness of less than or equal to 100 μm; a continuous nonporous hydrogen recombination catalyst coating layer having a first surface and a second surface, the first surface of the continuous hydrogen recombination catalyst coating layer on the first surface of the reinforced membrane, the continuous nonporous hydrogen recombination catalyst coating layer comprising a mixture of a recombination catalyst and a proton conducting ionomer; and a continuous nonporous cross-linked polyelectrolyte multilayer coating on the second surface of the continuous nonporous hydrogen recombination catalyst coating layer, the nonporous cross-linked polyelectrolyte multilayer coating comprising alternating layers of a polycation polymer and a polyanion polymer, and wherein the polycation polymer layer is in contact with the continuous nonporous hydrogen recombination catalyst coating layer; an anode on a second surface of the continuous nonporous cross-linked polyelectrolyte multilayer coating; and a cathode on the second surface of the reinforced membrane; or a cathode on a second surface of a second continuous nonporous polyelectrolyte multilayer coating on the second surface of the reinforced membrane.

A third embodiment of the invention is a method of preparing proton exchange membrane comprising applying a continuous nonporous hydrogen recombination catalyst coating layer directly on a first surface of a reinforced membrane, the continuous nonporous hydrogen recombination catalyst coating layer comprising a mixture of a recombination catalyst and a proton conducting ionomer, the reinforced membrane having a thickness of less than or equal to 100 μm; and applying a continuous nonporous cross-linked polyelectrolyte multilayer coating directly on a surface of the continuous nonporous hydrogen recombination catalyst coating layer, the continuous nonporous cross-linked polyelectrolyte multilayer coating comprising alternating layers of a polycation polymer and a polyanion polymer, wherein the polycation polymer layer is in contact with the continuous nonporous hydrogen recombination catalyst coating layer. An embodiment of the invention is one, any or all of prior embodiments in this paragraph up through the third embodiment in this paragraph wherein the reinforced membrane is a single layer membrane comprises a first reinforcement material and a first proton conducting ionomer, or a multilayer membrane comprising at least one reinforced membrane layer and at least one un-reinforced membrane layer, wherein the at least one reinforced membrane layer comprises a second reinforcement material and a second proton conducting ionomer and the at least one un-reinforced membrane layer comprises a third proton conducting ionomer. An embodiment of the invention is one, any or all of prior embodiments in this paragraph up through the third embodiment in this paragraph wherein the continuous nonporous hydrogen recombination catalyst coating layer further comprises a radical scavenger comprising CeO₂, Ce(OH)₄, CeO₂/ZrO₂, Ce(OH)₄/ZrO₂, or mixtures thereof. An embodiment of the invention is one, any or all of prior embodiments in this paragraph up through the third embodiment in this paragraph further comprising applying an anode directly on a second surface of the continuous nonporous cross-linked polyelectrolyte multilayer coating; and applying a cathode directly to a second surface of the reinforced membrane. An embodiment of the invention is one, any or all of prior embodiments in this paragraph up through the third embodiment in this paragraph wherein the first proton conducting ionomer, or the second proton conducting ionomer, or the third proton conducting ionomer, or combinations thereof comprises a perfluorosulfonic acid (PFSA) polymer selected from copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, or a copolymer of perfluoro-3-oxa-4-pentene-sulfonic acid and 2,2,4-trifluoro-5-trifluoromethoxy-1,3-dioxole, a non-PFSA polymer selected from sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, or cross-linked sulfonated poly(vinyl toluene), or combinations thereof. An embodiment of the invention is one, any or all of prior embodiments in this paragraph up through the third embodiment in this paragraph wherein the first reinforcement material, or the second reinforcement material, or both comprises polytetrafluoroethylene (PTFE), polyphenylene sulfide (PPS), polyvinylidene difluoride (PVDF), polychlorotrifluoroethylene (PCTFE), polyether ether ketone (PEEK), polyimide (PI), polyetherimide (PEI), polybenzoxazole (PBO), polybenzimidazole (PBI), polysulfone (PSF), polyethersulfone (PES), polyaramid, polypropylene (PP), polyethylene (PE), co-PP-PE, or combinations thereof. An embodiment of the invention is one, any or all of prior embodiments in this paragraph up through the third embodiment in this paragraph wherein the proton conducting ionomer in the continuous nonporous hydrogen recombination catalyst coating layer comprises a perfluorosulfonic acid (PFSA) polymer selected from copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, or a copolymer of perfluoro-3-oxa-4-pentene-sulfonic acid and 2,2,4-trifluoro-5-trifluoromethoxy-1,3-dioxole, a non-PFSA polymer selected from sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, or cross-linked sulfonated poly(vinyl toluene), or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A proton exchange membrane comprising:
a reinforced membrane having a first surface and a second surface, the reinforced membrane having a thickness of less than or equal to 100 μm;
a continuous nonporous hydrogen recombination catalyst coating layer having a first surface and a second surface, the first surface of the continuous hydrogen recombination catalyst coating layer on the first surface of the reinforced membrane, the continuous nonporous hydrogen recombination catalyst coating layer comprising a mixture of a hydrogen recombination catalyst and a proton conducting ionomer; and
a continuous nonporous cross-linked polyelectrolyte multilayer coating on the second surface of the continuous nonporous hydrogen recombination catalyst coating layer, the nonporous cross-linked polyelectrolyte multilayer coating comprising alternating layers of a polycation polymer and a polyanion polymer, and wherein the polycation polymer layer is in contact with the continuous nonporous hydrogen recombination catalyst coating layer.

2. The proton exchange membrane of claim 1 wherein the reinforced membrane comprises a single layer membrane comprising a first reinforcement material and a first proton conducting ionomer or a multilayer membrane comprising at least one reinforced layer and at least one un-reinforced layer, wherein the at least one reinforced layer comprises a second reinforcement material and a second proton conducting ionomer and the at least one un-reinforced layer comprises a third proton conducting ionomer.

3. The proton exchange membrane of claim 2 wherein the first proton conducting ionomer, or the second proton conducting ionomer, or the third proton conducting ionomer, or combinations thereof comprises a perfluorosulfonic acid (PFSA) polymer selected from copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, or a copolymer of perfluoro-3-oxa-4-pentene-sulfonic acid and 2,2,4-trifluoro-5-trifluoromethoxy-1,3-dioxole, a non-PFSA polymer selected from sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, or cross-linked sulfonated poly(vinyl toluene), or combinations thereof.

4. The proton exchange membrane of claim 2 wherein the first reinforcement material, or the second reinforcement material, or both comprises polytetrafluoroethylene (PTFE), polyphenylene sulfide (PPS), polyvinylidene difluoride (PVDF), polychlorotrifluoroethylene (PCTFE), polyether ether ketone (PEEK), polyimide (PI), polyetherimide (PEI), polybenzoxazole (PBO), polybenzimidazole (PBI), polysulfone (PSF), polyethersulfone (PES), polyaramid, polypropylene (PP), polyethylene (PE), co-PP-PE, or combinations thereof.

5. The proton exchange membrane of claim 1 wherein the thickness of the reinforced membrane is in a range of 10 to 90 μm.

6. The proton exchange membrane of claim 1 wherein the hydrogen recombination catalyst comprises Pt, Pt supported on carbon or silica, PtCo, PtCo supported on carbon or silica, Pd, Pd supported on carbon or silica, PdCo, PdCo supported on carbon or silica, or mixtures thereof.

7. The proton exchange membrane of claim 1 wherein the proton conducting ionomer in the continuous nonporous hydrogen recombination catalyst coating layer comprises a perfluorosulfonic acid (PFSA) polymer selected from copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, or a copolymer of perfluoro-3-oxa-4-pentene-sulfonic acid and 2,2,4-trifluoro-5-trifluoromethoxy-1,3-dioxole, a non-PFSA polymer selected from sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, or cross-linked sulfonated poly(vinyl toluene), or combinations thereof.

8. The proton exchange membrane of claim 1 wherein the continuous nonporous hydrogen recombination catalyst coating layer further comprises a radical scavenger.

9. The proton exchange membrane of claim 8 wherein the radical scavenger comprises CeO₂, Ce(OH)₄, CeO₂/ZrO₂, Ce(OH)₄/ZrO₂, or mixtures thereof.

10. The proton exchange membrane of claim 1 further comprising a second continuous nonporous polyelectrolyte multilayer coating on the second surface of the reinforced membrane.

11. The proton exchange membrane of claim 1 wherein the continuous nonporous cross-linked polyelectrolyte multilayer coating comprises at least two sets of alternating layers of the polycation polymer and the polyanion polymer.

12. The proton exchange membrane of claim 1 wherein a ratio of the proton conducting ionomer to the hydrogen recombination catalyst is in a range of 500:1 to 20:1.

13. A catalyst-coated membrane comprising:
a proton exchange membrane comprising;
a reinforced membrane having a first surface and a second surface, the reinforced membrane having a thickness of less than or equal to 100 μm;
a continuous nonporous hydrogen recombination catalyst coating layer having a first surface and a second surface, the first surface of the continuous hydrogen recombination catalyst coating layer on the first surface of the reinforced membrane, the continuous nonporous hydrogen recombination catalyst coating layer comprising a mixture of a recombination catalyst and a proton conducting ionomer; and
a continuous nonporous cross-linked polyelectrolyte multilayer coating on the second surface of the continuous nonporous hydrogen recombination catalyst coating layer, the nonporous cross-linked polyelectrolyte multilayer coating comprising alternating layers of a polycation polymer and a polyanion polymer, and wherein the polycation polymer layer is in contact with the continuous nonporous hydrogen recombination catalyst coating layer;
an anode on a second surface of the continuous nonporous cross-linked polyelectrolyte multilayer coating; and
a cathode on the second surface of the reinforced membrane; or a cathode on a second surface of a second continuous nonporous polyelectrolyte multilayer coating on the second surface of the reinforced membrane.

14. A method of preparing proton exchange membrane comprising:
applying a continuous nonporous hydrogen recombination catalyst coating layer directly on a first surface of a reinforced membrane, the continuous nonporous hydrogen recombination catalyst coating layer comprising a mixture of a recombination catalyst and a proton conducting ionomer, the reinforced membrane having a thickness of less than or equal to 100 μm; and
applying a continuous nonporous cross-linked polyelectrolyte multilayer coating directly on a surface of the continuous nonporous hydrogen recombination catalyst coating layer, the continuous nonporous cross-linked polyelectrolyte multilayer coating comprising alternating layers of a polycation polymer and a polyanion polymer, wherein the polycation polymer layer is in contact with the continuous nonporous hydrogen recombination catalyst coating layer.

15. The method of claim 14 wherein the reinforced membrane is a single layer membrane comprises a first reinforcement material and a first proton conducting ionomer, or a multilayer membrane comprising at least one reinforced layer and at least one un-reinforced layer, wherein the at least one reinforced layer comprises a second reinforcement material and a second proton conducting ionomer and the at least one un-reinforced layer comprises a third proton conducting ionomer.

16. The method of claim 14 wherein the continuous nonporous hydrogen recombination catalyst coating layer further comprises a radical scavenger comprising CeO₂, Ce(OH)₄, CeO₂/ZrO₂, Ce(OH)₄/ZrO₂, or mixtures thereof.

17. The method of claim 14 further comprising:
applying an anode directly on a second surface of the continuous nonporous cross-linked polyelectrolyte multilayer coating; and
applying a cathode directly to a second surface of the reinforced membrane.

18. The method of claim 15 wherein the first proton conducting ionomer, or the second proton conducting ionomer, or the third proton conducting ionomer, or combinations thereof comprises a perfluorosulfonic acid (PFSA) polymer selected from copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, or a copolymer of perfluoro-3-oxa-4-pentene-sulfonic acid and 2,2,4-trifluoro-5-trifluoromethoxy-1,3-dioxole, a non-PFSA polymer selected from sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, or cross-linked sulfonated poly(vinyl toluene), or combinations thereof.

19. The method of claim 15 wherein the first reinforcement material, or the second reinforcement material, or both comprises polytetrafluoroethylene (PTFE), polyphenylene sulfide (PPS), polyvinylidene difluoride (PVDF), polychlorotrifluoroethylene (PCTFE), polyether ether ketone (PEEK), polyimide (PI), polyetherimide (PEI), polybenzoxazole (PBO), polybenzimidazole (PBI), polysulfone (PSF), polyethersulfone (PES), polyaramid, polypropylene (PP), polyethylene (PE), co-PP-PE, or combinations thereof.

20. The method of claim 14 wherein the proton conducting ionomer in the continuous nonporous hydrogen recombination catalyst coating layer comprises a perfluorosulfonic acid (PFSA) polymer selected from copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, or a copolymer of perfluoro-3-oxa-4-pentene-sulfonic acid and 2,2,4-trifluoro-5-trifluoromethoxy-1,3-dioxole, a non-PFSA polymer selected from sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, or cross-linked sulfonated poly(vinyl toluene), or combinations thereof.
